(19) United States
(12) Patent Application Publication
(10) Pub. No.: US 2017/0083270 A1
(43) Pub. Date: Mar. 23, 2017

(54) DEVICE FOR SECURING A CLIENT APPLICATION FOR A SYMBOLOGY DISPLAY SYSTEM OF THE CLIENT-SERVER TYPE

(71) Applicant: THALES, Neuilly Sur Seine (FR)

(72) Inventors: Patrice Capircio, Le Haillan (FR); Pierre-Jean Turpeau, Le Haillan (FR); Patrick Joly, Le Haillan (FR)

(21) Appl. No.: 15/371,092

(22) Filed: Dec. 6, 2016

Related U.S. Application Data
(63) Continuation of application No. 14/174,488, filed on Feb. 6, 2014.

(30) Foreign Application Priority Data
Feb. 8, 2013 (FR) 1300287

(51) Int. Cl. G06F 3/14; B64D 43/00

(52) U.S. Cl. CPC G06F 3/14; B64D 43/00; H04L 67/42

(57) ABSTRACT

The device according to the invention, which makes it possible to secure a client application, including an acquisition and processing module of measured properties (GM) to generate properties of interest (GI); a lookup table associating each dynamic variable (VD) of each of the graphic objects to be maintained with a property of interest (GI); and a module for generating commands capable of issuing a command (C) to the server application. The device includes dedicated means for securing the operation of said acquisition and processing module; dedicated means for securing said lookup table; and dedicated means for securing said command generating module.

### CROSS-REFERENCE TO RELATED APPLICATION(S)

This application is a continuation of application Ser. No. 14/174,488, filed Feb. 6, 2014, which claims priority to French Patent Application No. 1300287, filed Feb. 8, 2013. The disclosures set forth in the referenced applications are incorporated herein by reference in their entirety.

### BACKGROUND

Technological Field

The invention relates to a secure client application for a symbology display system of the client-server type, the client application being capable of using instantaneous values of measured properties to generate a command to modify a graphic object interpreted by a server application of said display system, said graphic object corresponding to a symbol to be displayed in the form of an image on a graphic device of said display system.

Description of the Related Technology

Such a client-server display system is for example present in the cockpit of an aircraft.

A symbology is a method for using symbols to depict information graphically. A graphic symbol is made up of multiple elementary components, for example a straight segment forming a needle, an arc of circle bearing a graduation, etc.

The different information shown to the pilot includes some information called “critical” inasmuch as it is crucial, even vital, to pilot the aircraft.

In order to guarantee the integrity of critical information displayed by the graphic system, it is necessary to implement a scheme for securing the operation of the client-server display system.

Integrity must be understood here as the ability of a system to detect whether errors have occurred in calculations done or data manipulated by the system.

In a client-server display system, it is known to use the teaching of document FR 2,963,690 to guarantee the operating integrity of the server application executed on the server and the teaching of document FR 2,884,949 to guarantee the operating integrity of the graphic device.

### SUMMARY OF CERTAIN INVENTIVE ASPECTS

The invention therefore aims to complete the scheme for securing the operation of a display system of the client-server type by proposing a method and a device for guaranteeing the integrity of the processing chain for the client application information.

To that end, the invention relates to a device for securing a client application for a symbology display system of the client-server type, said client application being capable of using instantaneous values of measured properties to generate a command to modify a graphic object intended to be interpreted by a server application of said display system, said graphic object corresponding to a symbol to be displayed in the form of an image on a graphic device of said display system, characterized in that, said client application including:

an acquisition and processing module using the instantaneous values of measured properties as the input to generate instantaneous values of properties of interest;

a lookup table associating each dynamic variable of a set of dynamic variables of each of the objects maintained by the server application with a property of interest, said lookup table making it possible to assign the instantaneous value of the corresponding property of interest as the instantaneous value of a dynamic variable; and

a module for generating commands capable of issuing a command to the server application,

the device includes:

dedicated means for securing the operation of said acquisition and processing module;

dedicated means for securing said lookup table; and

dedicated means for securing said command generating module.

According to specific embodiments, the device includes one or more of the following features, considered alone or according to any technically possible combinations:

said acquisition and processing module making it possible to obtain a first set of instantaneous values for properties of interest, the means for securing the operation of the acquisition and processing module include: a redundancy module capable of generating a second set of instantaneous values for said properties of interest from instantaneous values of the measured properties; and a module for comparing the first and second sets of instantaneous values of the properties of interest.

the means for securing the operation of the module for generating commands include: a feedback module capable of generating at least one instantaneous value of a feedback variable, from a command issued at the output of the command generating module; and a verification module capable of comparing said instantaneous value of the feedback variable with an instantaneous value of a corresponding dynamic variable, which is applied at the input of the command generating module, or with an instantaneous value of a corresponding property of interest, which is obtained at the output of the acquisition and processing module.

the feedback module includes, for each graphic object, a control algorithm associated with said graphic object.

the means for securing said lookup table include a digital signature module capable of calculating an initial digital signature of said lookup table and verifying the integrity of said lookup table based on said initial digital signature.

The invention also relates to a symbology display system of the client-server type, including:

a client application capable of using instantaneous values of measured properties to generate a command to modify a graphic object;

a server application capable of interpreting a command received from the client application, in a graphic instruction; and

a display device capable of displaying said symbol in the form of an image as a function of the instruction received from the server application, characterized in that said client application includes:

an acquisition and processing module using the instantaneous values of measured properties as input to generate the instantaneous values of properties of interest;

a lookup table associating each dynamic variable of a set of dynamic variables for each of the objects maintained by the server application with a property of interest, said lookup table making it possible to assign the instantaneous value of the corresponding property of interest as the instantaneous value of a dynamic variable; and

a module for generating commands capable of issuing a command to the server application,

and in that the system includes a securing device according to the device above.

According to specific embodiments, a secure client application includes one or more of the following features, considered alone or according to any technically possible combinations:

the system includes a device for securing said server application and/or a device for securing said display application.

the client application and the securing device for said client application are run on a client computer and the server application is run on a server computer, said client computer being connected to said server computer by a communication network.

The invention also relates to a method for securely generating commands, implemented in a symbology display system of the client-server type, characterized in that it includes the following steps:

according to a primary chain:

acquiring and processing instantaneous values of measured properties to generate instantaneous values of properties interest;

matching each dynamic variable from a set of dynamic variables of the graphic object maintained by a server application of said symbology display system, with a property of interest, and assigning said instantaneous value of the corresponding property of interest as the instantaneous value of the dynamic variable; and

generating a command to update a symbology associated with the graphic object, during the modification of the instantaneous value of a dynamic variable of said object; and

according to a securing chain:

securing the acquiring and processing step;

securing the matching step; and

securing the step consisting of generating a graphic command.

The invention also relates to an information recording medium including instructions for carrying out a method described above.

By breaking the client application controlling the symbology down into a first module dedicated to processing the data and a second module dedicated to representation of that data, the first and second modules being associated through a lookup table, the securing of the application consists of independently securing the operation of the first module, the operation of the second module, the integrity of the lookup table and the integrity of the access mechanisms for the latter.

### BRIEF DESCRIPTION OF THE DRAWINGS

Advantageously, the present invention constitutes a generic solution, inasmuch as it does not depend on particular specifications of the client application (as long as the latter uses a predefined library of secure objects), or the server application, or the nature of the symbology used by the display system. The invention and its advantages will be better understood upon reading the following description, provided solely as an example, and done in reference to the appended drawings, in which:

FIG. 1 is a diagrammatic illustration of a symbology display system of the client-server type;

FIG. 2 is a block diagram of a secure client application belonging to the system of FIG. 1;

FIG. 3 is an example of a lookup table used in the client application of FIG. 2;

FIG. 4 is an illustration of the method for implementing the client application of FIG. 2.

### DETAILED DESCRIPTION OF CERTAIN INVENTIVE EMBODIMENTS

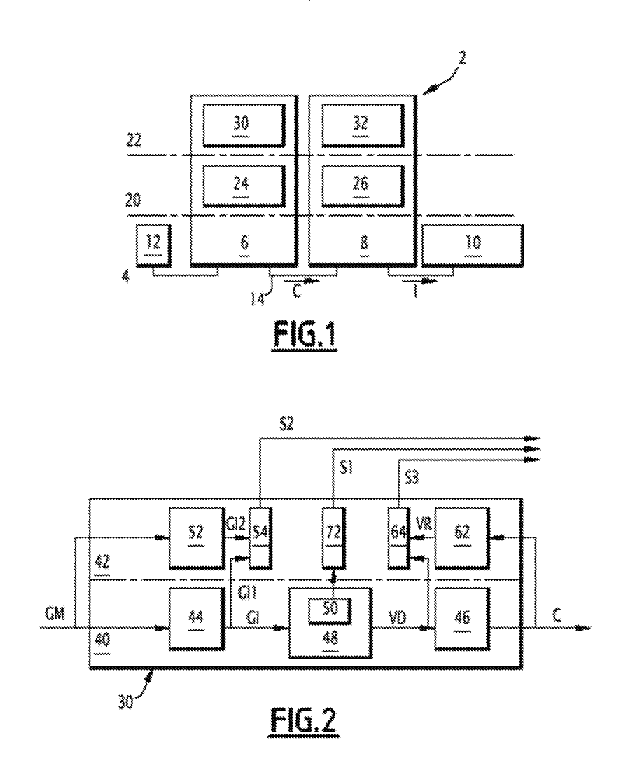

The display system 2 has an architecture of the client-server type. As shown in FIG. 1, the system 2 includes a hardware layer 4.

The hardware layer 4 includes a client computer 6, a server computer 8 and a display device 10.

Generically, the computer includes a computation unit, memory and an input/output interface.

The client computer 6 is connected to multiple sensors that are onboard the aircraft but are not part of the system 2. These sensors bear general reference 12 in FIG. 1.

The client and server computers 6 and 8 are in communication through a suitable network 14, for example of the ETHERNET type.

The display device 10 is directly connected to the server 8.

As shown in FIG. 1, the system includes a software layer.

The software layer is subdivided into an operating layer 20 and an application layer 22.

The operating layer 20 includes a client operating system 24, which is run on the client computer 6, and a server operating system 26, which is run on the server computer 8. As is known in itself, an operating system constitutes an interface between an application of the application layer and the different resources of the hardware layer 4.

The application layer 22 includes client software 30, which is run on the client computer 6, and a server application 32, which is run on the server computer 8.

An application is a computer program whereof the instructions are stored in the memory of the computer and which can be run by the computation unit of that computer.

The system 2 serves to display symbols on the display device 10 and update the symbols based on the evolution of the instantaneous values of the measurements delivered by the sensors 12, which those symbols are intended to represent.

In a manner known in itself, the server application 32 assumes the following form.

During a configuration phase, the server application is initialized so as to instantiate multiple graphic objects. Each of these graphic objects is associated with a symbol that can be displayed on the display device 10 during the use of the system 2.

The server application 32 is configured from a description file indicating all of the graphic objects that must be configured and updated by the server during the use of the system.

A graphic object constitutes a software implementation of an object graphic symbol. The objects provided by the system designer belong to a graphic library.

A graphic object includes static variables VS, the values of which are determined during the configuration of the object and cannot subsequently be modified.

A graphic object includes dynamic variables VD, the values of which are modified during the use of the system 2.

A graphic object includes display elements that respectively correspond to elementary components from which the symbol associated with the object is built. The notion of graphic object is characteristic of the client application and is not known by the server. In fact, the latter only knows the display elements that it provides to the client applications.

A graphic object includes different operators, and in particular, operators making it possible to modify the dynamic variables of the graphic object and, consequently, to modify the corresponding display elements to update the symbol displayed by the display device 10.

When it is run, the server application 32 is capable of receiving a command C issued by the client software 30.

The commands C belong to a communication standard that has been defined between the client and the server, for example in the avionics field, such as the ARINC 661 protocol.

The purpose of a command C is to modify the attributes of a display element that corresponds to the graphic object to be updated.

The attributes of a command C include the display element in question as well as the new values to be taken into account for the attributes of that display element following the update of the dynamic variables of the graphic object.

The server application 32 is then capable of transcribing the received command C in a stack of instructions in a graphic language, those instructions next being sent to the display device, so that the latter displays an updated symbol in the form of an image.

As shown in FIG. 2, the client software 30 includes a primary part 40, corresponding to the client application strictly speaking for generating graphic commands, and a securing part 42, corresponding to the device for securing the client application.

The purpose of the primary part 40 is to carry out a command generating chain C in the form of an image from the acquisition of measured properties GM measured by the sensors, while the purpose of the securing part 42 is to implement a chain for securing the command generating chain.

The primary part 40 of the client software 30 includes an acquisition and processing module 44, a command generating module 46, and a lookup module 48 including a lookup table 50 associating properties of interest GI at the output of the acquisition and processing module 44 and dynamic variables VD at the input of the command generating module 46.

The acquisition and processing module 44 is capable of acquiring the instantaneous values of measured properties GM and processing those values (by filtering, computation of elementary or complex functions, etc.) to deliver instantaneous values of properties of interest GI as output.

The measured properties GM are for example physical properties measured directly by the sensors 12, connected to the input/output interface of the client computer 6.

Alternatively, the measured properties are delivered by one or more other computation devices onboard the aircraft and outside the display system.

A symbol is an object that synthesizes one or more properties of interest GI in a single depiction. Similarly, a same property of interest GI may optionally be used in the development of several different symbols.

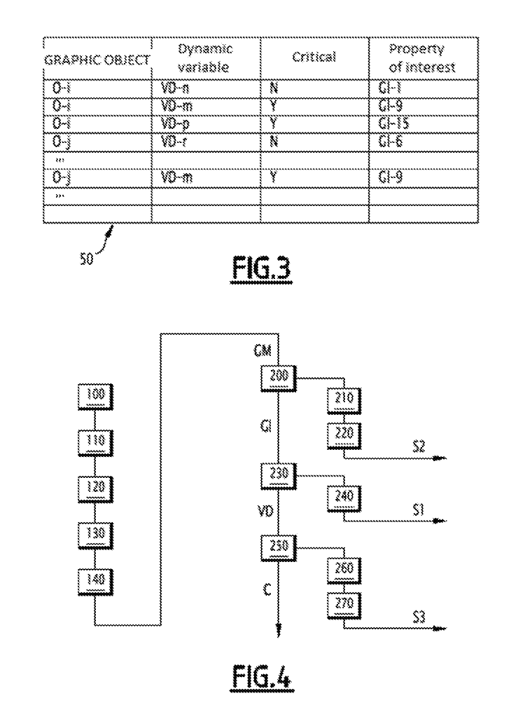

As illustrated by FIG. 3, the table 50 thus makes it possible to associate each dynamic variable VD of each graphic object Obj with a property of interest GI. Furthermore, the table 50 includes a field indicating whether the dynamic variable VD of the object Obj is critical or noncritical.

The table 50 is built in a configuration phase to account for graphic objects that the server application 32 must interpret during the use of the system 2. In particular, each object from the graphic library includes a flag for each dynamic variable indicating whether that variable is critical or noncritical. The value of that flag is copied in the table 50 during its configuration.

The module 48 is capable, based on the table 50, of assigning the instantaneous value of a property of interest GI to the different dynamic variables VD associated with said property of interest GI.

The command generating module 46 can be called upon periodically or when the instantaneous value of a dynamic variable VD is modified.

The module 46 is designed to generate one or more commands C for modifying display elements that correspond to the object whereof at least one dynamic property VD has evolved.

The module 46 is thus capable of generating a command C resulting from the modifications of dynamic variables VD of the graphic object in question. The module 46 is capable of sending the command thus generated to the server computer 8 via the communication network 14.

Among all of the information displayed in the form of symbols, certain information is critical within the meaning of that adjective provided above.

The issue of securing the processing chain of the critical dynamic variables VD during running of the client application consists of being able to detect the occurrence of an error in the generation of a command C relative to a critical dynamic variable VD.

The securing part 42 of the client application makes it possible to securely generate commands C using the primary part 40 of the client software 30.

In reference to FIG. 2, the securing part 42 includes a redundancy module 52 and a comparison module 54, a feedback module 62 and verification module 64, and a digital signature module 72.

As indicated above, in the configuration phase, the lookup table 50 is built by filling in, for each type of graphic object instantiated by the server application 32, and for each dynamic variable VD of that object, a field indicating whether the dynamic variable VD in question is critical, as well as the property of interest GI produced at the output of the acquisition and processing module 44 that must be associated with that dynamic variable VD.

Once the table 50 is configured, the digital signature module 72 is capable of carrying out a digital signature algorithm to generate an initial signature of the table 50.

Such a digital signature algorithm is known as such by one skilled in the art.

The module 72 is also capable, at any moment in the running of the client application, of computing the instantaneous signature of the table 50 and comparing it to the initial signature thereof.

If those two signatures are different, the module 72 is capable of issuing a first alarm signal S1 indicating that the table 50 is corrupt. The signature module thus makes it possible to guarantee the integrity of the table 50 during the operation of the system 2.

The redundancy system 52 consists of a duplication of the code of the acquisition and processing module 44, at least regarding the acquisition and processing leading to the determination of the properties of interest GI labeled as critical in the lookup table 50.

The module 52 can be run in parallel with the running of the acquisition and processing model 44 to obtain, from the same set of instantaneous values of measured properties GM, a first set of instantaneous values GI1 and a second set of instantaneous values GI2 of the critical properties of interest GI.

The comparison module 54 uses, as input, the first and second sets of instantaneous values GI1 and GI2 of the critical properties of interest and verifies whether a comparison criterion is respected between those instantaneous values.

If the comparison criterion is not respected, the module 54 is designed to generate an alarm signal S2.

Thus, the implementation of the redundancy module 52 and the comparison module 54 makes it possible to secure the acquisition and processing module 44 to determine the critical properties of interest GI.

The feedback module 62 is capable of verifying the consistency of the command C with the instantaneous values of the critical dynamic variable(s) VD whereof the modification caused the generation of the command C by the module 46.

The module 62 uses a command C sent to the server as input.

In the graphic object library, each object is associated with a control algorithm.

The feedback module 62 is then capable of identifying the object mentioned in the command C and calling the control algorithm associated with that graphic object. Using a reverse computation mechanism, the control algorithm is able to determine the instantaneous values of multiple feedback variables VR from attributes of the command C. The verification module 64 is designed to verify that at each moment, the instantaneous values of the feedback variables VR correspond to those of the critical dynamic variables VD applied at the input of the module for generating commands 46.

The verification module 64 is capable of determining whether the instantaneous values of the critical dynamic variables VD and the feedback variables VR respect a verification criterion.

If that criterion is not respected, the module 64 is capable of generating a third alarm signal S3.

Thus, the implementation of the feedback 62 and verification 64 modules allows securing of the command generating module 46, at least for the generation of commands relative to dynamic variables labeled as critical in the lookup table 50.

The method for securely generating graphic commands implemented when the client software 30 is run is as follows.

In a prior configuration phase, the description file is read to instantiate multiple graphic objects.

In step 100, the table 50 is built by filling in, for each instantiated object Obj, and for each dynamic variable VD of that object, a field indicating whether the dynamic variable in question is critical, as well as the property of interest GI produced at the output of the acquisition and processing module 44 that must be associated with that dynamic variable.

In step 110, the digital signature module 72 is run once the table 50 has been configured, so as to determine an initial digital signature of the table 50.

The acquisition and processing module having been developed upstream, in step 120, the redundancy module 52 is generated by duplicating the code of the acquisition and processing module 44, at least regarding the acquisition and processing leading to the determination of properties of interest GI labeled as critical in the table 50.

In a phase for running the secured client software 30, the acquisition and processing module 44 is run periodically (step 200) to acquire instantaneous values of measured properties GM measured by the sensors 12 and process those instantaneous values to determine the instantaneous values of properties of interest GI.

Each running of the acquisition and processing module 44 is followed by the running of the redundancy module 52 (step 210). As long as the running of the module 44 makes it possible to determine a first set of instantaneous values GI1 of the critical properties of interest GI, the running of the module 52 makes it possible to determine a second set of instantaneous values GI2 of the critical properties of interest GI.

Then, in step 220, after running the module 62, the comparison module 64 is run to verify that, for each critical property of interest GI, the instantaneous value of the first set and the instantaneous value of the second set respect the comparison criterion used by the module 64. If the comparison criterion is not respected, the module 64 generates an alarm signal S2.

In step 230, the lookup module 48 is run. Reading the lookup table 50 makes it possible to assign each instantaneous value of a property of interest GI obtained at the output of step 200, as instantaneous value of the dynamic variable VD associated with that property interest.

After the module 48 has accessed the table 50, the digital signature module 72 is run to compute the current digital signature of the table 50 and compare it to the initial signature (step 240).

If no property of interest GI has been modified, the module 72 verifies that the current digital signature of the table 50 is still identical.

If properties of interest GI have been modified, the module 72 verifies that the non-modified parts of the table 50 are identical to the previous ones and that the updates of the values of the dynamic variables VD indeed correspond to the modifications of the properties of interest GI.

In case of inconsistency, the module 72 generates an alarm signal S1.

When a dynamic variable VD is modified, the command generating module 46 is run (step 250) to generate commands C necessary to modify the display elements of the corresponding object. To that end, the generating module 46 generates a command C making it possible, based on the modifications of variables VD of the concerned graphic object, to ask the server computer 8 for modifications of the attributes of the display elements. Once the command C is generated, the module 46 sends it over the network 14 to the server 8.

When the dynamic variable VD whereof the instantaneous value has been modified is a critical dynamic variable VD, the feedback module 62 is run (step 260), following the running of the command generating module 46.

The module 62 uses the command C issued by the command generating module 46 as input and applies the control algorithm associated with that attribute object of the command C, so as to compute the instantaneous values of the feedback variables VR.

Then, in step 270, the verification module 64 is run to verify that the instantaneous values of the feedback variables VR correspond to those of the critical dynamic variables VD used at the input of the command generating module 46. The verification module 64 is capable of determining whether the instantaneous values of the critical dynamic variables and the feedback variables respect a verification criterion. If that criterion is not respected, the module 64 issues an alarm signal S3.

One skilled in the art will know how to use the different alarm signals generated by the modules 54, 64 and 72 of the securing device of the client software 30.

The implementation of the secured client application with a server and a display generating device that in turn are secured makes it possible to ensure the integrity of the critical symbology display chain on the client-server display system.

In the present description, the client and server computers have been shown as being separate from each other. However, it is possible to consider running the client and server applications on the same computer, for example in different logic partitions sharing the same hardware resources. The command exchange from the client partition to the server partition may for example be done by a virtual message exchange bus between partitions, mechanism known by those skilled in the art.

Similarly, the primary and securing parts of the client application have been shown as belonging to the same application on the client computer. In fact, these parts are run separately either on different partitions, or on different computers. Synchronization mechanisms between the two parts must then be implemented.

In the embodiment described above, errors may occur during copying of the instantaneous value of a property of interest in the memory space associated with a dynamic variable. This risk therefore propagates the calculation of the digital signature of the table 50, part of which is not constant, since it varies over the course of the updates of the properties of interest GI as a function of the evolution of the measured properties GM. Alternatively, to simplify the computation module for the digital signature of the lookup table 50, it is possible for the verification module to make it possible to compare the instantaneous value of a feedback variable obtained at the output of the feedback module not with the instantaneous value of the dynamic variable VD anymore, but with the instantaneous value of the corresponding property of interest GI, as indicated by the lookup table 50.

What is claimed is:

1. A device for securing a client application for a symbology display system of the client-server type onboard an aircraft, said client application using instantaneous values of measured properties relating to flight of the aircraft to generate a command to modify a graphic object intended to be interpreted by a server application of said display system, said graphic object corresponding to a symbol to be displayed in the form of an image on a graphic device of said display system, wherein said client application includes:
an acquisition and processing module using instantaneous values of measured properties relating to flight of an aircraft as inputs to generate instantaneous values of properties of interest;
a lookup table associating each dynamic variable of a set of dynamic variables of each of the objects maintained by the server application with a property of interest, said lookup table assigning the instantaneous value of the corresponding property of interest as the instantaneous value of a dynamic variable; and
a software module for generating commands and issuing a command to the server application, and
wherein the device includes:
dedicated software configured to secure the operation of said acquisition and processing module;
dedicated software configured to secure said lookup table; and
dedicated software configured to secure the operation of said command generating module.

2. The device according to claim 1, wherein, a first set of instantaneous values for properties of interest are obtained from said acquisition and processing module, and wherein the dedicated software configured to secure the operation of the acquisition and processing module include:
a redundancy module configured to generate a second set of instantaneous values for said properties of interest from instantaneous values of the measured properties; and
a comparison module configured to compare the first and second sets of instantaneous values of the properties of interest.

3. The device according to claim 1, wherein the means for securing the operation of the module for generating commands include:
a feedback module configured to generate at least one instantaneous value of a feedback variable, from a command issued at the output of the command generating module; and
a verification module configured to compare said instantaneous value of the feedback variable with an instantaneous value of a corresponding dynamic variable, which is applied at the input of the command generating module, or with an instantaneous value of a corresponding property of interest, which is obtained at the output of the acquisition and processing module.

4. The device according to claim 3, wherein the feedback module includes, for each graphic object, a control algorithm associated with said graphic object.

5. The device according to claim 1, wherein the dedicated software configured to secure said lookup table include a digital signature module calculating an initial digital signature of said lookup table and verifying the integrity of said lookup table based on said initial digital signature.

6. A symbology display system of the client-server type onboard an aircraft, the symbology display including:
a client application using instantaneous values of measured properties relating to flight of the aircraft to generate a command to modify a graphic object;
a server application interpreting a command received from the client application, in a graphic instruction; and
a display device displaying said symbol in the form of an image as a function of the instruction received from the server application,
wherein said client application includes:
an acquisition and processing module using the instantaneous values of measured properties as inputs to generate the instantaneous values of properties of interest;
a lookup table associating each dynamic variable of a set of dynamic variables for each of the objects maintained by the server application with a property of interest, said lookup table assigning the instantaneous value of the corresponding property of interest as the instantaneous value of a dynamic variable; and
a software module for generating commands and issuing a command to the server application, and in that the system includes a securing device according to claim 1.

7. The symbology display system according to claim 6, including a device for securing said server application and/or a device for securing said display application.

8. The symbology display system according to claim 6, wherein the client application and the securing device for said client application run on a client computer and the server application runs on a server computer, said client computer being connected to said server computer by a communication network.

9. A method of securely generating commands, implemented in a symbology display system of the client-server type onboard an aircraft, the method comprising:
according to a primary chain:
acquiring and processing instantaneous values of measured properties relating to flight of the aircraft to generate instantaneous values of properties of interest;
matching each dynamic variable from a set of dynamic variables of the graphic object maintained by a server application of said symbology display system, with a property of interest, and assigning said instantaneous value of the corresponding property of interest as the instantaneous value of the dynamic variable; and
generating a command to update a symbology associated with the graphic object, during the modification of the instantaneous value of a dynamic variable of said object; and
according to a securing chain:
securing the acquiring and processing of instantaneous values;
securing the matching of each dynamic variable; and
securing the generation of a graphic command.

10. An non-transitory computer-readable medium comprising instructions for carrying out a method for securely generating graphic commands according to claim 9, when the instructions are run by a client computer of a symbology display system of the client-server type.
